(19) United States
(12) Patent Application Publication
(10) Pub. No.: US 2018/0025329 A1
(43) Pub. Date: Jan. 25, 2018

(54) SYSTEM AND METHOD FOR MANAGING WASTE SERVICES

(71) Applicant: Rubicon Global Holdings, LLC, Altanta, GA (US)

(72) Inventors: Samantha Spring PODGORNY, Cumming, GA (US); Ryan Keith ALEXANDER, Sugar Hill, GA (US)

(73) Assignee: Rubicon Global Holdings, LLC, Altanta, GA (US)

(21) Appl. No.: 15/216,449

(22) Filed: Jul. 21, 2016

(51) Int. Cl. G06Q 10/00; G06Q 30/04; G01S 19/13; G06Q 10/06

(52) U.S. Cl. CPC G06Q 10/30; G06Q 10/063114; G06Q 30/04; G01S 19/13

(57) ABSTRACT

A system is disclosed for managing waste services. The system may have a locating device configured to generate a signal indicative of a location of a service vehicle, an input device, and a controller in communication with the locating and input devices. The controller may be configured to receive input via the input device that is indicative of at least one of a plurality of locations to be serviced by the service vehicle within a service area not being serviced. The controller may also be configured to make a determination based on the signal from the locating device that the service vehicle has left the service area and, based on the input and the determination, automatically record into memory remaining locations of the plurality of locations as having been serviced.

### TECHNICAL FIELD

The present disclosure relates generally to a management system and method, and more particularly, to a system and method for managing waste services.

### BACKGROUND

Residential waste service providers typically dispatch service vehicles to customer properties according to a predetermined pickup route assigned to each service vehicle. The pickup route for each service vehicle is often designed to provide waste services (e.g., to empty waste receptacles) within a particular geographical area (e.g., a subdivision) and at a particular frequency (e.g., once per week). For example, a particular service vehicle may be tasked to service several hundred waste receptacles at closely-spaced residences within a particular subdivision on a particular day of the week. After completion of the waste services within that subdivision, the service vehicle operator may report the completion to a back office, which updates the operator's route and an account record for each customer. Customers in the subdivision that subscribe to these waste services are then billed based on the account record.

In some instances, service of a particular receptacle at a particular residence may not be completed. For example, it may be possible for the service vehicle to arrive at a residence where no receptacle was placed out for service. In another example, it may be possible that the receptacle was placed out, but damaged, spilled, filled with restricted materials, or otherwise rendered unserviceable. In yet another example, it may be possible for the service vehicle operator to inadvertently pass by a residence without performing service, even if the receptacle was properly placed out and serviceable. In these situations, a clear record of services being performed or not being performed may be helpful for customer relations.

Historically, confirmation of service being performed at a particular residence was attained manually. In particular, the operator of the service vehicle would manually check off a paper list each time the service was performed for a given route, sub-route, or specific residence/location, and/or provide reasons for any service that was not performed. While this approach may have been successful in some instances, it was also problematic. In particular, the manual confirmation was tedious and drew the operator's time and attention away from the actual service being performed and/or operation of the service vehicle. As a result, manual confirmation may not have been performed and/or a danger to property and life was increased. In addition, the manual confirmation provided hundreds of opportunities for error during each work shift.

The disclosed system and method are directed to overcoming one or more of the problems set forth above and/or other problems of the prior art.

### SUMMARY

In one aspect, the present disclosure is directed to a system for managing waste services. The system may include a locating device configured to generate a signal indicative of a location of a service vehicle, an input device, and a controller in communication with the locating and input devices. The controller may be configured to receive input via the input device that is indicative of at least one of a plurality of locations to be serviced by the service vehicle within a service area not being serviced. The controller may also be configured to make a determination based on the signal from the locating device that the service vehicle has left the service area and, based on the input and the determination, automatically record into memory remaining locations of the plurality of locations as having been serviced.

In another aspect, the present disclosure is directed to a method for managing waste services. The method may include generating a signal indicative of a location of a service vehicle, and receiving manual input that is indicative of at least one of a plurality of locations to be serviced by a service vehicle within a service area not being serviced. The method may also include making a determination based on the signal that the service vehicle has left the service area and, based on the input and the determination, automatically recording into memory remaining locations of the plurality of locations as having been serviced.

In yet another aspect, the present disclosure is directed to a non-transitory computer readable medium containing computer-executable programming instructions for performing a method of waste service management. The method may include generating a signal indicative of a location of a service vehicle, and receiving manual input that is indicative of at least one of a plurality of locations to be serviced by a service vehicle within a service area not being serviced. The method may also include making a determination based on the signal that the service vehicle has left the service area and, based on the input and the determination, automatically recording into memory remaining locations of the plurality of locations as having been serviced.

### BRIEF DESCRIPTION OF THE DRAWINGS

FIG. 1 is a perspective illustration of an exemplary disclosed waste management environment;

FIG. 2 is a diagrammatic illustration of an exemplary disclosed system that may be used to manage the environment of FIG. 1;

FIG. 3 is a flowchart illustrating an exemplary disclosed method of managing waste services that may be performed by the system of FIG. 2; and

FIG. 4 is a diagrammatic illustration of exemplary disclosed graphical user interfaces that may be used to access the system of FIG. 2.

### DETAILED DESCRIPTION

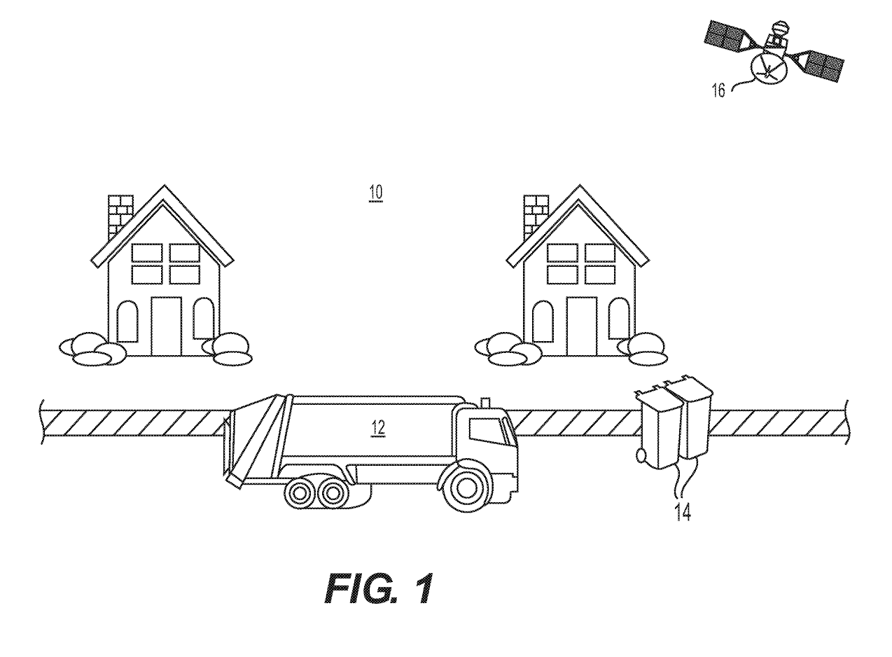

FIG. 1 illustrates an exemplary waste management environment (“environment”) 10, at which one or more service vehicles 12 are providing waste services. Environment 10 may include any number of retail stores, factories, government buildings, residential addresses, or other locations having one or more receptacles 14 that require the service of service vehicle 12. The service may include, for example, the removal of waste materials from inside of receptacle 14, the replacement of receptacle 14, and/or the placement of new or additional receptacles 14.

Vehicle 12 may embody a haul truck (and/or a trailer that is attachable to the haul truck), which includes or otherwise carries a storage compartment for holding waste materials. As is known in the art, the storage compartment may have a rear, side, and/or top hatch for receiving materials from receptacles 14, and the waste materials may be manually, automatically, or semi-automatically loaded into the storage compartment of a particular vehicle 12 via the corresponding hatch. For example, management personnel may be able to manually lift and tilt receptacles 14 into the storage compartment of a rear-hatch vehicle 12, thereby emptying receptacle 14 of the associated waste. In another example, vehicles 12 may include mechanical, electrical, and/or hydraulic systems configured to automatically grasp, lift, tilt, shake, and thereby empty receptacles 14 into vehicle 12 via a top-hatch. In yet another example, some tasks (e.g., grasping) may be completed manually and other tasks (e.g., lifting, tilting, and shaking) may be completed with the assistance of the mechanical, electrical, and/or hydraulic systems via a side-hatch of vehicle 12. In a final example, receptacle 14 may simply be loaded (e.g., manually, automatically, or semi-automatically) together with the waste contents onto vehicle 12 and transported away for emptying at another location.

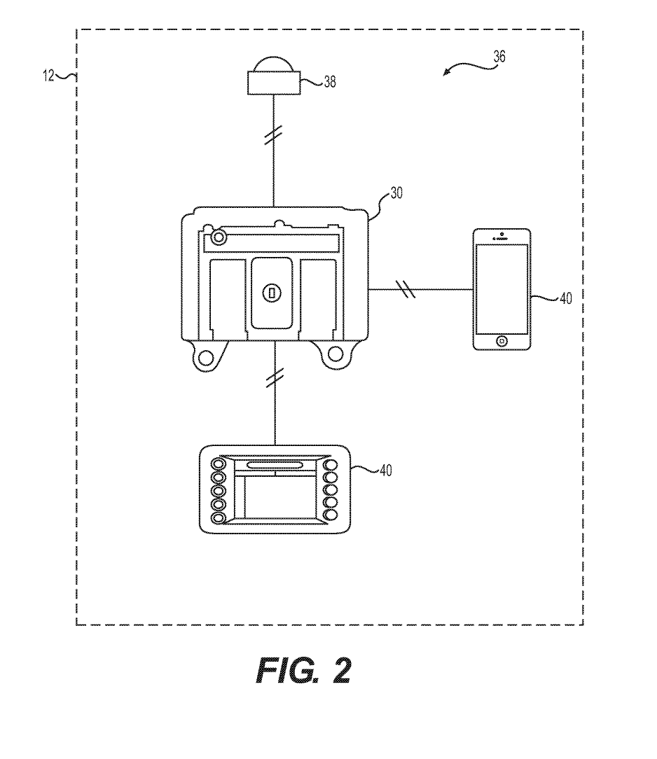

As each vehicle 12 moves about environment 10, a satellite 16 or other tracking device may communicate with an onboard controller 30 (shown only in FIG. 2) to monitor the movements of vehicle 12 and the associated changes made to environment 10 (e.g., pickup, transporting, dumping, placing, etc.). As will be explained in more detail below, onboard controller 30 may facilitate management of service activities performed by vehicle 12 based on the tracked movements and changes.

Onboard controller 30 may include means for monitoring, recording, storing, indexing, processing, communicating, and/or controlling other onboard and/or offboard devices. These means may include, for example, a memory, one or more data storage devices, a central processing unit, or any other components that may be used to run the disclosed application. Furthermore, although aspects of the present disclosure may be described generally as being stored in memory, one skilled in the art will appreciate that these aspects can be stored on or read from different types of computer program products or computer-readable media such as computer chips and secondary storage devices, including hard disks, floppy disks, optical media, CD-ROM, or other forms of RAM or ROM.

As shown in FIG. 2, onboard controller 30 may form a portion of a waste management system (“system”) 36 that is configured to track, assist, and/or control movements of service vehicle(s) 12 (shown only in FIG. 1). In addition to onboard controller 30, system 36 may also include a locating device 38 and at least one input device 40 mounted or otherwise located onboard each service vehicle 12. Onboard controller 30 may be in communication with each of these other components and configured to determine, based on signals from these components and based on other known information stored in memory, the location of each service vehicle 12 and characteristics and locations of receptacles 14 being moved by and/or in a vicinity of each service vehicle 12.

Locating device 38 may be configured to generate signals indicative of a geographical position and/or orientation of service vehicle 12 relative to a local reference point, a coordinate system associated with environment 10, a coordinate system associated with Earth, or any other type of 2-D or 3-D coordinate system. For example, locating device 38 may embody an electronic receiver configured to communicate with satellites 16 (referring to FIG. 1), or a local radio or laser transmitting system used to determine a relative geographical location of itself. Locating device 38 may receive and analyze high-frequency, low-power radio or laser signals from multiple locations to triangulate a relative 3-D geographical position and orientation. Based on the signals generated by locating device 38 and based on known kinematics of service vehicle 12, onboard controller 30 may be able to determine in real or near real time, the position, heading, travel speed, acceleration, and orientation of service vehicle 12. This information may then be used by onboard controller 30 to update the locations and conditions of service vehicle(s) 12 and/or receptacles 14 in an electronic map or database of environment 10.

Input device 40 may provide a way for an operator of service vehicle 12 to manually input information regarding observances made while traveling around environment 10. For example, the operator may be able to enter a type and/or condition of waste observed at a particular location, an amount of waste in or around receptacle 14, a fill status of a particular receptacle 14, a condition of receptacle 14, a location of receptacle 14, and or other information about receptacle 14 and the waste engaged by, loaded into, or otherwise processed by service vehicle 12. The information may be input in any number of ways, for example via a cab-mounted touch screen interface, via one or more buttons, via a keyboard, via speech recognition, via a mobile device (e.g., a smartphone or tablet) carried by the operator, or in another manner known in the art. In addition to receiving manual input from an operator, input device 40 may also be capable of displaying information, for example the electronic map of environment 10, instructions, scheduling, routing, receptacle information (e.g., ID, configuration, location, weight, etc.), payload information (e.g., weight and/or volume), etc.

In some embodiments, input device 40 may be configured to execute an application. For example, when input device 40 is a mobile device (for example a smartphone), the application can be a mobile app (“app”). An app is an abbreviated term for a “software application”, which is downloadable to and executable by a mobile device (e.g., a laptop, a smart phone, or a tablet). The disclosed waste management app can provide a graphical user interface (GUI) configured to display information about a waste service to the operator of service vehicle 12, to receive input from the operator regarding a completed or incomplete service activity, to transmit the operational data to onboard controller 30, to receive and display information about a current operation, etc.

Onboard controller 30 may be configured to manage communications between other onboard components (and, in some instances, between onboard and offboard components). For example, onboard controller 30 may receive signals from locating device 38 and input device(s) 40, and correlate the signals, filter the signals, buffer the signals, record the signals, or otherwise condition the signals.

Onboard controller 30, based on the information received from onboard service vehicle 12, can be configured to execute instructions stored on computer readable medium to perform methods of waste service management at environment 10. For example, onboard controller 30 may be configured to monitor when service vehicle 12 has crossed a geo-fence into a particular service area while following an assigned route (e.g., based on tracked location), when service vehicle 12 has stopped, when service vehicle 12 has neared and/or passed by a target location within the service area, and when an operator has provided input (e.g., indicated via input device 40) that a scheduled service is not possible. This monitoring may then be used to create a record of confirmed services, to determine route assignments for service vehicle 12, to determine business costs and efficiencies, to determine service opportunities, to make route adjustments, to bill customers, etc.

For the purposes of this disclosure, a geo-fence may be considered a virtual boundary surrounding at least a portion of an assigned service route. The portion of the assigned service route encompassed by the geo-fence may be, for example, a high-density area of residential customers subscribing to waste services by the provider of system 36. Examples of a service area encompassed by a particular geo-fence may include a city block, a grouping of blocks, or a subdivision. As the corresponding service vehicle 12 crosses the virtual boundary of the geo-fence into the service area, onboard controller 30 may be detect the crossing based on the comparison of the tracked location of service vehicle 12 and the known location of the geo-fence. Likewise, as the corresponding service vehicle 12 crosses the virtual boundary of the geo-fence out of the service area, onboard controller 30 may again detect the crossing. In addition, onboard controller 30 may include stored in memory or in an associated database a listing of all target locations within the service area that should be serviced by service vehicle 12 while service vehicle 12 is traveling inside the service area (i.e., before service vehicle 12 leaves the service area). It is contemplated that a route assigned to a particular service vehicle 12 could include any number of service areas with corresponding geo-fences.

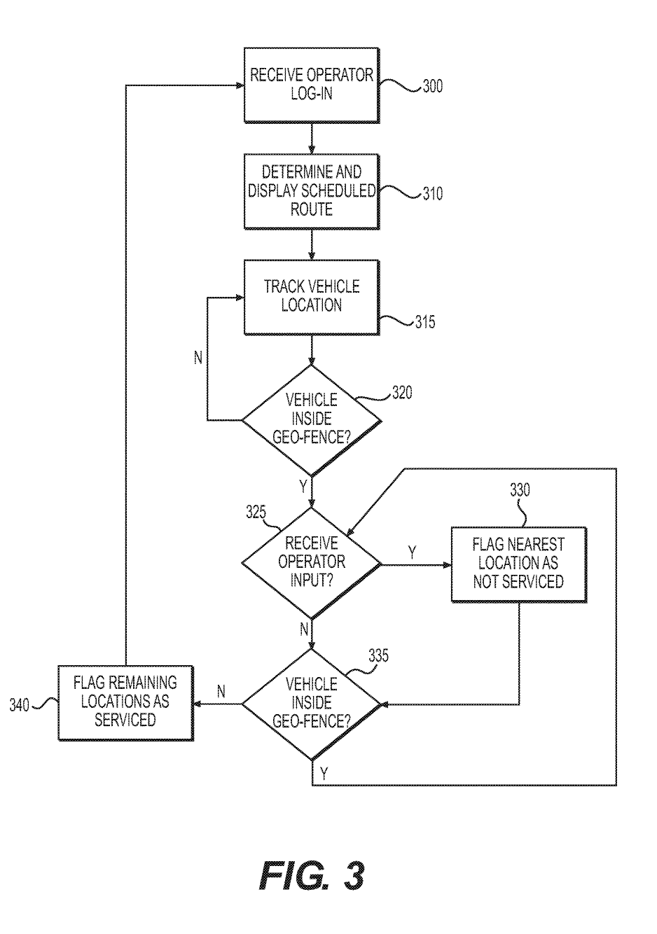

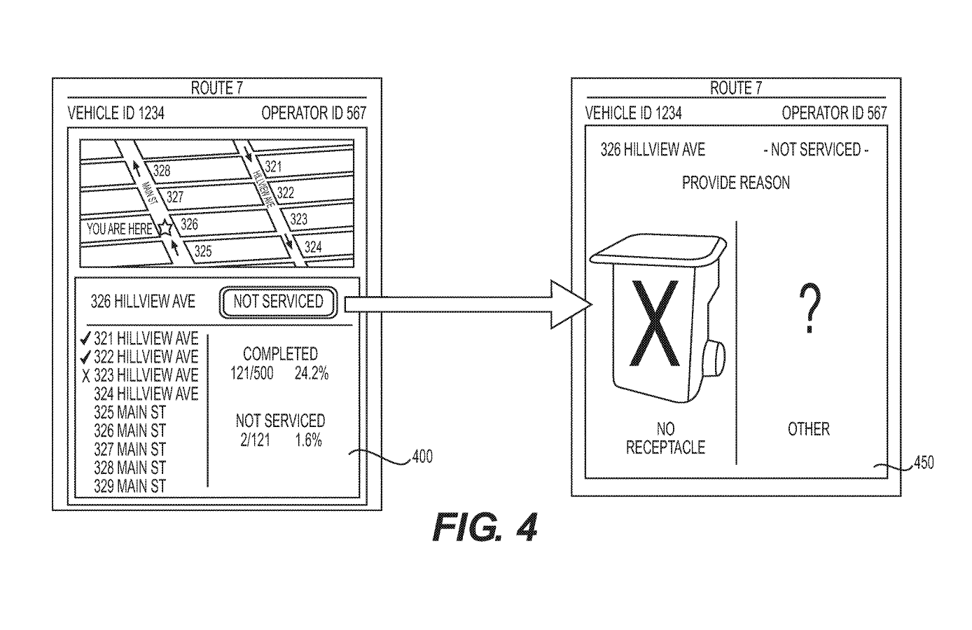

An exemplary process of waste service management that may be performed by onboard controller 30 is illustrated in FIG. 3 and will be explained in more detail in the following section to further illustrate the disclosed concepts. In addition, FIG. 4 represent exemplary Graphical User Interfaces (GUIs) that may be shown in connection with the disclosed waste management app on any input device 40 for use by an operator of service vehicle 12 to access system 36. FIG. 4 will also be discussed in greater detail below to further illustrate the disclosed concepts.

### INDUSTRIAL APPLICABILITY

The disclosed system, method, and app may be applicable to the waste service industry, where efficient management of waste services can affect public safety, vehicle safety, customer service, billing, and profitability of a service provider. The disclosed system, method, and app may create a way for individual service vehicle operators to confirm in a simple and organized manner that a particular service at a particular target location has been completed. For example, the disclosed system, method, and app may provide graphical user interfaces (GUIs) allowing the operator to see an assigned route of target locations at which service should be provided. The GUIs of the disclosed app may also allow the operator to view the location of service vehicle 12 relative to the target locations, and to indicate (e.g., via input device 40) if any of the target locations are unserviceable and/or that service has not been performed at a particular target location. The GUIs provided by the disclosed app may also relay to the operator visual directions to the target locations locations, provide visual status indicators associated with confirmed service activities, and provide a way for the operator to give feedback or other input regarding the service activities, the target locations, the service vehicle 12, the route, etc. The disclosed method will now be explained in detail with reference to FIG. 3.

As seen in FIG. 3, the method implemented by onboard controller 30 may begin when a vehicle operator logs into the disclosed app (Step 300). During this login, the operator may provide, for example, an identification of the operator and/or of the particular service vehicle 12 that will be driven by the operator for the given work shift. In some embodiments, the operator and/or vehicle identification may also or alternatively be auto-determined (e.g., based on a detected route, ID tag, etc.). Onboard controller 30 may then determine and display a route of target locations that the operator should service during the work shift (Step 310). In some instances, the route may be determined automatically by onboard controller 30, for example based on the service vehicle identification, the operator identification, the day of the week, or another similar factor. In other instances, the route may be manually selected (e.g., by the operator and/or a supervisor) from among a plurality of available routes. Display of the route may include, among other things, a listing of the target locations and/or service areas, directions to the target locations and/or service areas, a map of the target locations and/or service areas, service information about each target location (e.g., an expected number and/or size of receptacles 14 at each target location), and/or a schedule of when each target location should be serviced.

After receiving the assigned route (e.g., as electronic data stored inside input device 40), the operator may drive service vehicle 12 toward a first service area (e.g., a neighborhood, a city section, a collection of streets, etc.) in the assigned route. During this travel, onboard controller 30 may track the location of service vehicle 12 (Step 315), and continuously compare the tracked location to the known location of the geo-fence surrounding the first service area (Step 320). In particular, onboard controller 30 may determine when service vehicle 12 has crossed the geo-fence into the first service area. Until service vehicle crosses the geo-fence, control may loop back to step 315.

However, when onboard controller 30 determines that service vehicle 12 has entered the first service area (e.g., by comparing the monitored location of service vehicle 12 to the known location of the geo-fence), controller 30 may await input from the operator (Step 325). The input may be received via input device 40 and include, among other things, an indication that a scheduled service could not be and/or was not performed. As will be described in more detail below, the operator may be able to select and/or provide reasons for the uncompleted service, in some embodiments. In response to the input being received at step 325, onboard controller 30 may be configured to flag (e.g., in memory and/or on input device 40) a nearest one of the target locations (e.g., nearest based on the tracked location of service vehicle 12 and the known positions of the target locations on the assigned route at the time that the input was received) as having not been serviced (Step 330). It is noted that, in some instances, no input may be provided at step (325), for example when all target locations are serviceable. In this situation, control may still proceed to the next step.

During servicing of receptacles 14 at the target locations within the first service area, onboard controller 30 may continuously determine if service vehicle 12 has crossed the geo-fence back out of the first service area (Step 335). Step 335 may be performed following step 325 when no operator input is received and/or following step 330 after generating the incomplete service flag. As long as service vehicle 12 remains in the first service area, control may loop from step 335 back to step 325. In other words, onboard controller 30 may assume that the scheduled activities in the first service area are not yet finished until service vehicle 12 has exited the first service area.

When onboard controller 30 determines at step 335 that service vehicle 12 has left the first service area, onboard controller 30 may responsively flag all of the remaining target locations (i.e., the target locations not yet already flagged as unserviceable) as being service-confirmed (Step 340). In other words, onboard controller 30 may determine by exception that if a particular target location was not already flagged as having not been serviced, service must have been completed in the required manner at the target location. Control may then return to step 300 for a repeat of the method at a next service area in the assigned route.

FIG. 4 shows exemplary GUIs 400 and 450, which may be used to facilitate the process that is described above and shown in FIG. 3. GUIs 400 and 450 may be shown on any onboard input device 40 (referring to FIG. 2) and, as can be seen in FIGS. 3 and 4, may correspond with steps 300-340 in the flowchart of FIG. 3.

For example, after login of the vehicle operator to the disclosed app, GUI 400 may be displayed on input device 40 showing an assigned route number, the entered vehicle identification number, the entered operator identification number, a map of the assigned route, a current (e.g., nearest) location of service vehicle 12 inside a service area geo-fence, and a list of target locations in the service area that require the services of service vehicle 12. In addition, GUI 400 may facilitate the operator of service vehicle 12 providing the input of step 325. This may include, for example, providing an actual or virtual “Not Serviced” button shown adjacent a listing of a current target location that, when activated, provides the input to onboard controller 30 signifying that the current location is unserviceable. GUI 400 may also illustrate which of the target locations have been serviced, which (if any) are unserviceable, and which have not yet been visited by service vehicle 12. It is contemplated that the visited target locations may be determined in real or near real time as the tracked location of service vehicle 12 is shown to pass near by the target locations without the input of step 325 being received (i.e., without the operator pushing the “Not Serviced” button), or determined only after service vehicle 12 has left the service area as described in step 340. In some embodiments, parameters associated with the servicing of the target locations may be calculated and displayed within GUI 400. These parameters may include, among other things, a measure of how much of the assigned route and/or service area has been completed (e.g., how many target locations have been serviced, how many target locations remain, a percent of completion, etc.) and how much of the assigned route and/or service area is unserviceable (e.g., how many target locations were passed by without being serviced, a percent of unserviceable target locations, etc.).

When the operator of service vehicle 12 activates the “Not Serviced” button of GUI 400, GUI 450 may be responsively displayed on input device 40. GUI 450 may provide a way for the operator of service vehicle 12 to explain why a target location was not serviced. For example, the operator may be able to activate a first button indicating that no receptacle 14 was placed out for servicing. In another example, the operator may be able to activate a second button indicating that another reason exists for the lack of performed service. In some embodiments, after activating the second button, the operator may be able to input notes regarding the other reason.

The interfaces illustrated in FIG. 4 are exemplary only and are provided to highlight certain aspects of the disclosed system. Other views and functionality are contemplated, as would be understood by one of skill in the art. It will be apparent to those skilled in the art that various modifications and variations can be made to the disclosed system. Other embodiments will be apparent to those skilled in the art from consideration of the specification and practice of the disclosed system. It is intended that the specification and examples be considered as exemplary only, with a true scope being indicated by the following claims and their equivalents.

1. A system for managing waste services, comprising:
a tracking device configured to generate a signal indicative of a location of one or more service vehicles;
an input device; and
a controller in communication with the tracking and input devices, the controller being configured to:
monitor location data of the one or more service vehicles using a respective location device;
monitor one or more service vehicle actions made to a respective service environment by one or more service vehicles;
receive input via the input device that is indicative of one or more service locations that are unserviced by the one or more service vehicles;
make a determination based on the signal from the respective location device that one or more service vehicles have left one or more service locations based on a crossing location of a geo-fence surrounding a respective service location of the one or more service locations;
based on the input and the determination, automatically record into memory a portion of one or more of the one or more service locations having been serviced and actions made in those locations; and
transmit an updated service assignment based on the recorded portion of one or more of the one or more service locations having been serviced and actions made in the respective one or more service locations.

2. (canceled)

3. The system of claim 1, wherein the controller is further configured to provide a graphical user interface for display on the input device, the graphical user interface displaying one or more locations as being unserviced and remaining locations as being serviced.

4. The system of claim 1, wherein the input is received when a user activates a button on the input device indicating that one of the one or more service locations was not serviced.

5-7. (canceled)

8. The system of claim 1, wherein the controller is further configured to generate billing based on the portion of the one or more of the one or more service locations and actions made in those locations that were recorded into the memory.

9. A method for managing waste services, executed by a controller in communication with a tracking device and an input device, the tracking device being configured to generate a signal indicative of a location of one or more service vehicles, the method comprising:
monitoring location data of one or more service vehicles using a respective location device;
monitoring one or more service vehicle actions made to a respective service environment by the one or more service vehicles;
receiving manual input that is indicative of one or more service locations that are unserviced by the one or more service vehicles;
making a determination based on the signal from the respective location device that one or more service vehicles have left one or more service areas based on a crossing location of a geo-fence surrounding a respective service area of the one or more service locations;
based on the input and the determination, automatically recording into a memory a portion of one or more of the one or more service locations having been serviced and actions performed in the respective one or more service locations; and
transmitting an updated service assignment based on the recorded portion of one or more of the one or more service locations having been serviced and actions made in the respective one or more service locations.

10. (canceled)

11. The method of claim 9, further comprising:
providing a graphical user interface displaying one or more service locations as being unserviced and remaining locations as being serviced.

12-14. (canceled)

15. The method of claim 9, further comprising:
generating billing based on the portion of the one or more of the one or more service locations and actions made in those locations that were recorded into memory.

16. A non-transitory computer readable medium containing computer-executable programming instructions for performing a method of waste service management, the method comprising:
monitoring location data of one or more service vehicles using a respective location device;
monitoring one or more service vehicle actions made to a respective service environment by the one or more service vehicles;
receiving manual input that is indicative of one or more service locations that are unserviced by the one or more service vehicles;
making a determination based on signals from the respective location device that one or more service vehicles have left the one or more service locations based on a crossing location of a geo-fence surrounding a respective service area of the one or more service locations;
based on the input and the determination, automatically recording into a memory a portion of one or more of the one or more service locations having been serviced and actions performed in the respective one or more service locations; and
transmitting an updated service assignment based on the recorded portion of one or more of the one or more service locations having been serviced and actions made in the respective one or more service locations.

17-19. (canceled)

20. The non-transitory computer readable medium of claim 16, wherein the method further comprises:
determining in response to an input selected on a graphical user interface, that a portion of a first service location is unserviceable.

21. The system of claim 1, wherein the controller is further configured to determine one or more partially serviced locations based on the input, determination, and the monitored location data.

22. The system of claim 21, wherein the controller is further configured to automatically determine a respective route for one or more service vehicles to the one or more partially serviced locations based on the location data of the one or more service vehicles and the determination of the one or more partially serviced locations.

23. The system of claim 21, wherein the controller is further configured to determine a percentage of the one or more partially serviced locations that was serviced based on the monitored one or more service vehicle actions made to the respective service environment.

24. The method of claim 9, further comprising determining one or more partially serviced locations based on the input, determination, and the monitored location data.

25. The method of claim 24, further comprising automatically determining a respective route for one or more service vehicles to the one or more partially serviced locations based on the location data of the one or more service vehicles and the determination of the one or more partially serviced locations.

26. The method of claim 25, further comprising transmitting an assigned route to a first service vehicle to a first service area.

27. The method of claim 24, wherein determining one or more partially serviced locations further includes determining unserviceable portions of the one or more partially serviced locations.

28. The non-transitory computer readable medium of claim 16, wherein the method further comprises determining one or more partially serviced locations based on the input, determination, and the monitored location data.

29. The non-transitory computer readable medium of claim 28, wherein the method further comprises automatically determining a respective route for one or more service vehicles to the one or more partially serviced locations based on the location data of the one or more service vehicles and the determination of the one or more partially serviced locations.

30. The non-transitory computer readable medium of claim 29, wherein the method further comprises transmitting an assigned route to a first service vehicle to a first service area.

31. The non-transitory computer readable medium of claim 28, wherein determining one or more partially serviced locations further includes determining unserviceable portions of the one or more partially serviced locations.
